(19) United States
(12) Patent Application Publication
(10) Pub. No.: US 2009/0165870 A1
(43) Pub. Date: Jul. 2, 2009

(54) Manifold assembly

(75) Inventor: M. Howard Konishi, Kirkland, WA (US)

Correspondence Address: GRAYBEAL JACKSON LLP, 155 - 108TH AVENUE NE, SUITE 350, BELLEVUE, WA, 98004-5973, US

(73) Assignee: Macro Technologies, Inc., Kirkland, WA (US)

(21) Appl. No.: 12/286,534

(22) Filed: Sep. 29, 2008

Related U.S. Application Data
(60) Provisional application No. 60/995,893, filed on Sep. 28, 2007.

(51) Int. Cl. F16K 21/04

(52) U.S. Cl. 137/511

(57) ABSTRACT

A manifold assembly for use with compressed gas cylinders, apparatus having CGA-870 compliant fittings and refilling/conserving apparatus to permit a user to selectively direct compressed gas from the refilling/conserving apparatus to the CGA-870 compliant apparatus and/or coupled compressed gas cylinder. The assembly includes a housing having a fill interface having at least one fill port, an outlet interface having at least one outlet port, and a cylinder interface having at least one port where a first fluid conduit fluidly coupling the outlet interface with the cylinder interface and a second fluid conduit fluidly coupling the inlet interface with the cylinder interface wherein the second fluid conduit has no unidirectional flow restriction means. To prevent back flow from the outlet port to the cylinder port, a one-way valve is used. In certain embodiments, one end each of the first and second fluid conduits separately terminate at the cylinder interface.

### SUMMARY OF THE INVENTION

The invention relates to a manifold assembly for use with a CGA-870 compliant post assembly, a male coupler that is receivable by the post assembly and a standard ambulatory oxygen bottle. The manifold assembly of the invention embodiments comprises a housing defining a plurality of fluid conduits where the housing may be of a singular piece or plural pieces functionally coupled together. As used herein, the term “fluid” comprises liquid and/or gas phases of matter, including colloidal suspensions of solid phase matter. The housing further defines a plurality of ports or interfaces with the environment when the housing is not integrated into a system, as will be described below. In addition, at least one unidirectional flow restriction means is incorporated into the housing to permit and prevent fluid flow within at least one selected conduit and into/out of at least one port.

The invention is intended to be used in conjunction with a source of compressed gas and a reservoir for compressed gas such as a cylinder, as well as apparatus that use compressed gas. Thus, there is a “fill”, “store” and “use” functionality associated with these embodiments when integrated into a system. In certain embodiments of the invention, the housing replaces a conventional CGA 870 post valve, which conventionally threadably couples to an oxygen cylinder intended to store compressed oxygen, and provides a special outlet port from which the oxygen may be directed upon operation of a valve that modulates gas flow from the cylinder to the outlet port. Housings according to the invention provide a separate fill port to enable a user to refill the cylinder without using the CGA 870 port for such operations.

In particular, housings according to the invention comprise a fill interface having at least one fill port, an outlet interface having at least one outlet port, and a cylinder interface having at least one port. A first fluid conduit fluidly couples the outlet interface with the cylinder interface while a second fluid conduit fluidly couples the inlet interface with the cylinder interface. Disposed between the outlet interface and the cylinder interface is a first unidirectional flow restriction means, which is preferably a mechanical interference seal biased into a normally closed position and operable when presented with a fluid pressure differential sufficient to overcome the bias. Disposed between the inlet interface and the cylinder interface is a second unidirectional flow restriction means, which is preferably a mechanical interference seal biased into a normally closed position and operable when presented with a fluid pressure differential sufficient to overcome the bias. The first unidirectional flow restriction means (hereinafter “UFRM”) is positioned such that it substantially blocks fluid flow from the outlet interface to the cylinder interface either alone or in combination with other structure. Similarly, the second UFRM is positioned such that it substantially blocks fluid flow from the cylinder interface to the fill interface either alone or in combination with other structure. Both the first UFRM and the second UFRM can be physically separate from the housing when the system is not in use, but must be operationally coupled to the housing in order for the manifold assembly to operate as intended.

In one series of embodiments, the first UFRM is disposed in the housing and within the first fluid conduit. The first fluid conduit has no other ports fluidly between the outlet interface and the cylinder interface. The first UFRM is positioned such that fluid may flow relatively unobstructed from the cylinder interface to the outlet interface, but is substantially prevented from flowing from the outlet interface to the cylinder interface. In a preferred form, the first UFRM comprises cartridge check valve threadably inserted into the first fluid conduit at the cylinder interface.

Similarly, the second UFRM can be disposed in the housing and within the second fluid conduit. The second fluid conduit has no other ports fluidly between the fill interface and the cylinder interface. The second UFRM is positioned such that fluid may flow relatively unobstructed from the fill interface to the cylinder interface, but is substantially prevented from flowing from the outlet interface to the cylinder interface. In such embodiments, the second UFRM may be disposed proximate to the fill interface or the cylinder interface. In view of the nominal diameter of the cylinder interface, one series of embodiments comprises the second UFRM being disposed proximate to the fill interface.

An alternative to the foregoing embodiments is to have the second UFRM be disposed in an auxiliary structure that can be fluidly coupled to the fill interface of the housing where the auxiliary structure is fluidly between a source of pressurized fluid and the fill interface during operation of the manifold assembly as intended. When coupled to the housing, that portion of the auxiliary structure mostly fluidly proximate to the source of pressurized fluid can also be considered the fill port given the similar functionality to the housing fill port.

In this latter series of embodiments, the auxiliary structure can remain associated with the source of pressurized fluidthe housing and within the second fluid conduit. The second fluid conduit has no other ports fluidly between the fill interface and the cylinder interface. The second UFRM is positioned such that fluid may flow relatively unobstructed from the fill interface to the cylinder interface, but is substantially prevented from flowing from the cylinder interface to the fill interface. In such embodiments, the second UFRM may be disposed proximate to the fill interface or the cylinder interface. In view of the nominal diameter of the cylinder interface, one series of embodiments comprises the second UFRM being disposed proximate to the fill interface to reduce potential interference with the first UFRM is located proximate to the cylinder interface.

Ready access to the UFRMs is considered desirable from both a manufacturing (installation) as well as maintenance (repair/replace) perspective. Because the outlet interface in many embodiments of the invention is not amenable to modification, the only remaining interfaces are the fill interface and the cylinder interface. Therefore, it is considered preferable to dispose on UFRM at the cylinder interface, and one at the fill interface. As noted previously, either or both URFMs may be disposed in auxiliary structure that is functionally associated with the housing during operation of the invention embodiments in the intended applications.

In those embodiments wherein a UFRM is disposed proximate to the cylinder interface, this first UFRM will generally reside at a port interface. This position favors the establishment of a separate second fluid conduit that is not directly fluidly coupled with the first fluid conduit. In other words, effective fluid coupling between the first and second conduits only takes place when a cylinder is coupled to the cylinder interface and is pressurized to a level sufficiently different than a pressure at the outlet interface to operate and open the first UFRM.

While fluid flow from the fill interface to the cylinder interface can be regulated by modulation of the pressurized fluid, embodiments of the invention provide for a first valve means operatively disposed between the cylinder interface and the outlet interface. In this manner, fluid flow from the cylinder interface can be modulated by a user.

In a preferred application, select embodiments of the invention replace a conventional CGA 870 post valve commonly found on medical compressed oxygen cylinders or bottles. These post valves provide an outlet interface that couples with selected medical oxygen dispensing apparatus. Federal regulations prohibit a user from directly connecting a cylinder refilling apparatus to any dispensing apparatus, but do permit end users to “refill” their own oxygen bottles. Embodiments of the invention intended to exploit this advantage without requiring specialized hardware retain the basic functionality of the CGA 870 post valve, but also provide means for fluidly coupling a source of compressed oxygen without the requirement for alteration of the cylinder of post valve. A simple coupling of the source of compressed oxygen will open the second UFRM to permit fluid to flow into any coupled cylinder. When a predefined pressure differential is met (or reversed), the UFRM closes. Back filling of the cylinder from the outlet interface is prevented by the first UFRM. Dispensing of the compressed oxygen from the cylinder is then regulated by the valve means.

For purposes of this patent, the terms “area”, “boundary”, “part”, “portion”, “surface”, “zone”, and their synonyms, equivalents and plural forms, as may be used herein and by way of example, are intended to provide descriptive references or landmarks with respect to the article and/or process being described. These and similar or equivalent terms are not intended, nor should be inferred, to delimit or define per se elements of the referenced article and/or process, unless specifically stated as such or facially clear from the several drawings and/or the context in which the term(s) is/are used.

### BRIEF DESCRIPTION OF THE DRAWINGS

FIG. 1 is a plan view of a manifold assembly according to the invention wherein first and second fluid conduits are shown in phantom;

FIG. 2 is a cross sectional view of the embodiment of FIG. 1 taken substantially along the lines 2-2;

FIG. 3 is a cross sectional view of the embodiment of FIG. 1 taken substantially along the lines 3-3; and

FIG. 4 is a first end elevation view particularly illustrating the cylinder interface and ports.

### DESCRIPTION OF THE PREFERRED EMBODIMENTS

Preface: The terminal end of any numeric lead line in the several drawings, when associated with any structure or process, reference or landmark described in this section, is intended to representatively identify and associate such structure or process, reference or landmark with respect to the written description of such object or process. It is not intended, nor should be inferred, to delimit or define per se boundaries of the referenced object or process, unless specifically stated as such or facially clear from the drawings and the context in which the term(s) is/are used. Unless specifically stated as such or facially clear from the several drawings and the context in which the term(s) is/are used, all words and visual aids should be given their common commercial and/or scientific meaning consistent with the context of the disclosure herein.

With the foregoing in mind, the following description is presented to enable a person skilled in the art to make and use the claimed invention. Various modifications to the described embodiments will be readily apparent to those skilled in the art, and the generic principles disclosed herein may be applied to other embodiments and applications thereof without departing from the spirit and scope of the present invention, as defined by the appended claims. Thus, the claimed invention is not intended to nor should be limited to the disclosed and/or described embodiments, but is to be accorded the widest scope consistent with the principles and features disclosed herein.

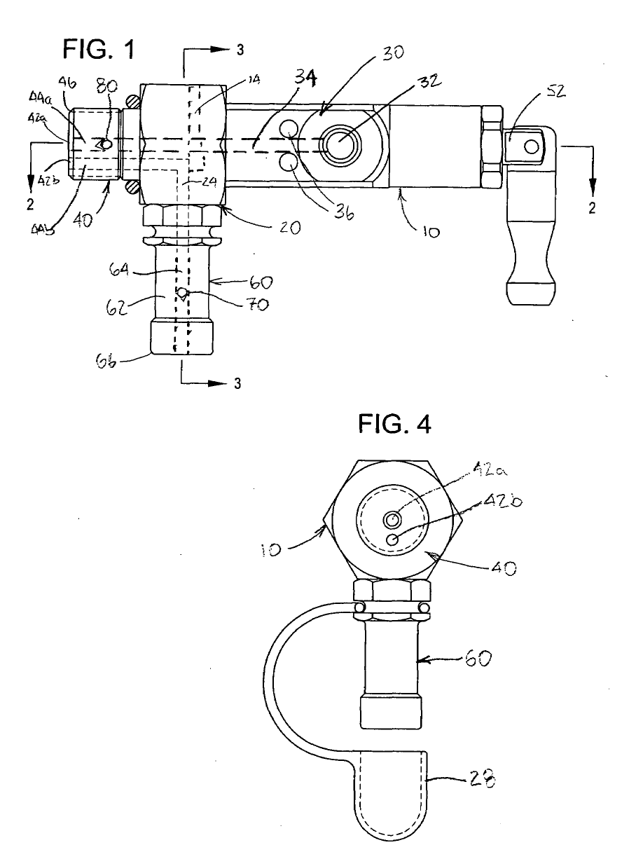

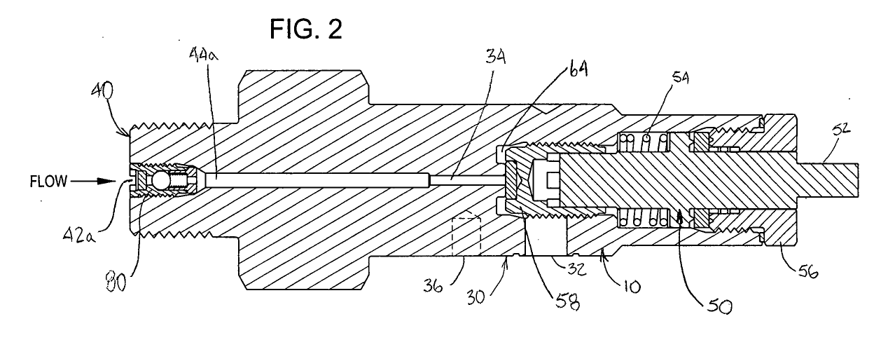

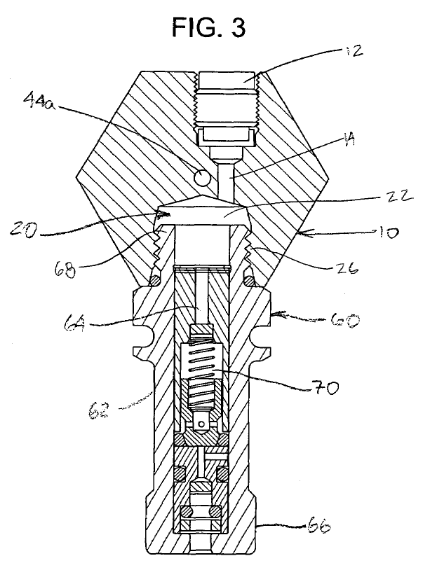

Turning then to the several drawings, and more particularly to FIGS. 1-4, a manifold assembly embodiment according to the invention is shown. The manifold assembly comprises housing 10, which is preferably constructed from a durable material as will be appreciated by the skilled practitioner. Housing 10 includes three primary interfaces, namely, fill interface 20, outlet interface 30, and cylinder interface 40. Each interface includes a port: fill interface 20 has fill port 22; outlet interface 30 has outlet port 32; cylinder interface 40 has cylinder ports 42a and 42b. As schematically shown in FIG. 1 and by cross section in FIGS. 2 and 3, each port is linked to at least one other port via internal conduits: fill port 22 is fluidly coupled to cylinder port 42b via fill conduit 24, which transitions to conduit 44b proximate to fill port 22; outlet port 32 is fluidly coupled to cylinder port 42a via outlet conduit 34, which transitions to fill conduit 44a.

To ensure proper directional movement of fluid introduced at fill interface 20, and prevent unintentional movement of fluid from outlet interface 30 (federal regulations prohibit delivery of compressed gas or fluid from a CGA-870 compliant fitting), check valve 80, in addition to valve assembly 50, is provided between outlet port 32 and cylinder port 42a. This check valve prevents fluid flow both to cylinder port 42a as well as cylinder port 42b, which is in turn fluidly coupled to fill port 22 (the latter functionality is only true when an article such as a cylinder or the like having a sealable chamber is fluidly coupled to cylinder interface 40 such that cylinder port 42a is fluidly coupled to cylinder port 42b in a closed system).

To prevent back flow of fluid or pressurized gas from cylinder port 42b to fill port 22 and subsequently to the environment when a source of fluid or pressurized gas is not present, coupler 60 is provided at fill interface 20, as best shown in FIG. 3. Poppet assembly 70 is disposed in the fluid path between inlet end 66, which couples with threaded portion 26 of fill interface 20, and outlet end 68, which couples with a source of pressurized gas or fluid, such as from an oxygen conservation apparatus.

To regulate delivery of compressed gas or fluid to outlet port 32, valve assembly 50 is functionally disposed between outlet port 32 and any existing or potential source of pressurized gas or fluid, which in the illustrated embodiment is proximate to outlet port 32.

To ensure the safe use and operation of the illustrated manifold assembly, fuse conduit 14 is exposed at one end to fill conduit 24 and to pressure/temperature fuse 12 at the other end. Thus, if the temperature and/or pressure of incoming pressurized gas or fluid exceeds a certain threshold, fuse 12 will fail, thereby venting to the environment all compressed gas or fluid in the manifold assembly as well as any cylinder coupled to cylinder interface 40 (additionally any further introduced compressed gas or fluid will also find escape). However, because of check valve 80, no gas or fluid from conduit 44a or any apparatus coupled to outlet interface 30 will be similarly vented.

As stated above, a primary purpose of the illustrated manifold assembly is to permit convenient recharging of a compressed gas or fluid cylinder by a recharging means fluidly coupled to a source, as well as the immediate use of the source of compressed gas or fluid by an apparatus fluidly coupled to the outlet interface of the assembly.

1. A manifold assembly for use with a CGA-870 compliant post assembly, a male coupler that is receivable by the post assembly and includes a first unidirectional flow restriction means, and a standard ambulatory oxygen cylinder comprising:
a housing comprising a fill interface having at least one fill port, an outlet interface having at least one outlet port, and a cylinder interface having at least one port;
a first fluid conduit fluidly coupling the outlet interface with the cylinder interface;
a second fluid conduit fluidly coupling the inlet interface with the cylinder interface wherein the second fluid conduit has no unidirectional flow restriction means; and
first unidirectional flow restriction means disposed between the outlet interface and the cylinder interface for substantially preventing fluid from moving from the outlet interface to the cylinder interface.

2. The manifold assembly of claim 1 further comprising a valve disposed between the outlet interface and the cylinder interface.

3. The manifold assembly of claim 1 wherein one end each of the first and second fluid conduits separately terminate at the cylinder interface.

4. The manifold assembly of claim 1 wherein the first and second fluid conduits are fluidly coupled only when the cylinder is coupled to the cylinder interface.

5. The manifold assembly of claim 1 wherein one end of the second fluid conduit forms a port at the cylinder interface and whereby pressurized fluid presented thereto will migrate towards and escape from another end thereof at the inlet interface unless the coupler is connected thereto.
